(19) United States
(12) Patent Application Publication
(10) Pub. No.: US 2023/0045871 A1
(43) Pub. Date: Feb. 16, 2023

(54) CHARACTER RECOGNITION METHOD, COMPUTER PROGRAM PRODUCT WITH STORED PROGRAM AND COMPUTER READABLE MEDIUM WITH STORED PROGRAM

(71) Applicant: FOOTPRINTKU INC., Kaohsiung City (TW)

(72) Inventors: YAN-JHIH WANG, Kaohsiung City (TW); YUNG-SUNG CHEN, Kaohsiung City (TW); YU-CHENG HU, Kaohsiung City (TW); JIUN-HUEI HO, Kaohsiung City (TW); SHIH-FENG HUANG, Kaohsiung City (TW); TZUNG-PEI HONG, Kaohsiung City (TW)

(21) Appl. No.: 17/399,386

(22) Filed: Aug. 11, 2021

(51) Int. Cl. G06K 9/34; G06K 9/20; G06K 9/32; G06N 3/04; G06K 9/62

(52) U.S. Cl. CPC G06K 9/344; G06K 9/2054; G06K 9/3233; G06N 3/04; G06K 9/6215; G06K 2209/01

(57) ABSTRACT

A character recognition method includes inputting an input image of a document, with the input image including a plurality of characters; selecting the plurality of characters through an object detection module to form at least one character region; separating the plurality of characters in the at least one character region to form a plurality of character boxes; performing calculation to determine a format of a character in each of the plurality of character boxes; recognizing the characters in the at least one character region through an object recognition module to determine a symbol content of the character in each of the plurality of character boxes; and converting the plurality of characters according to the format and symbol content of the character in each of the plurality of character boxes, and outputting corresponding editable characters.

### BACKGROUND OF THE INVENTION

### 1. Field of the Invention

The present invention relates to an image recognition method and, more particularly, to a character recognition method for recognizing a character format and a symbol content thereof, a computer program product with a stored program and a computer readable medium with the stored program.

### 2. Description of the Related Art

Current optical character recognition system mainly includes an image scanner, an optical character recognition module and an output interface. The image scanner scans a document into an image, and inputs the image to the optical character recognition module for character recognition. According to pre-stored reference characters, the optical character recognition module converts pattern characters in the image into systematic characters that may be edited on a computer to generate a document file. Lastly, the document file is transmitted by the output interface to other computer application programs.

The above-mentioned conventional optical character recognition system cannot recognize formats such as superscripts and subscripts of the characters, which results in that vocabularies and meanings presented by the characters in the document file are different from the contents of the sentences in the original document.

In light of this, it is necessary to improve the conventional optical character recognition system.

### SUMMARY OF THE INVENTION

It is therefore an objective of the present invention to provide a character recognition method that can recognize formats of characters.

It is another objective of the present invention to provide a computer program product with a stored program and a computer readable medium with the stored program, which are configured to execute the above-mentioned method.

It may be understood by one of ordinary skill in the art that the “computer” used herein refers to a variety of data processing apparatuses having a specific function and implemented with hardware or hardware and software, such as a server, a virtual machine (e.g. Amazon and Azure), a desktop computer, a laptop, a tablet or a smartphone.

It may be understood by one of ordinary skill in the art that the “computer program product” used herein refers to an object which is stored with a computer readable program and is not limited by an external form thereof.

It may be understood by one of ordinary skill in the art that the “computer readable medium” used herein refers to a carrier on which software is stored, and the software may be accessed by a computer and typically includes an optical disc, a hard disk, a Universal Serial Bus (USB) flash drive, various memory cards, and cloud or virtual memory spaces.

As used herein, the term “one”, “a” or “an” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

A character recognition method according to the present invention includes inputting an input image of a document, with the input image including a plurality of characters; selecting the plurality of characters through an object detection module to form at least one character region, and acquiring an image coordinate of the at least one character region in the input image; separating the plurality of characters in the at least one character region into independent characters to form a plurality of character boxes, and acquiring a central coordinate, a height value and a width value of each of the plurality of character boxes; performing calculation according to the central coordinate, the height value and the width value of each of the plurality of character boxes as well as the image coordinate of the at least one character region to determine a format of a character in each of the plurality of character boxes; recognizing the characters in the at least one character region through an object recognition module to determine a symbol content of the character in each of the plurality of character boxes; and converting the plurality of characters in the input image into corresponding editable characters according to the format and the symbol content of the character in each of the plurality of character boxes, and outputting the plurality of editable characters.

The present invention discloses a computer program product with a stored program and a computer readable medium with the stored program, which are capable of performing the above method after a computer system loads and executes the stored program. Therefore, the above method may be used, interchanged or executed conveniently, such that the character recognition method is widely applied to other application software.

Accordingly, the character recognition method, the computer program product with the stored program and the computer readable medium with the stored program according to the present invention can select a plurality of characters in an input image of a document to form at least one character region; separate the plurality of characters in the character region to form a plurality of character boxes and acquire data such as a central coordinate, a height value and a width value of each character box; then perform calculation according to the data of each character box and an image coordinate of the character region to determine a format of a character in each character box; additionally recognize the characters in the character region through an object recognition module to determine a symbol content of the character in each character box; and then convert the plurality of characters in the input image into corresponding editable characters according to the format and symbol content of the character in each character box, and output the plurality of editable characters. Therefore, the character recognition method, the computer program product with the stored program and the computer readable medium with the stored program according to the present invention can achieve the effect of recognizing formats such as upper cases, lower cases, superscripts and subscripts of the characters.

In an example, the object detection module may generate the at least one character region in the input image through an object detection network. Thus, when the confidence of the object detection module detecting an object is high, the operation may be stopped and the result may be output.

In an example, the character recognition method further includes performing a projection method on the input image to acquire a separation point between two upper and lower adjacent lines of characters in the input image, configured for the object detection module to respectively select characters on different lines according to the separation point to form a plurality of character regions. Thus, by separating two upper and lower adjacent lines of characters, the object detection module respectively detects the characters on different lines.

In an example, when a plurality of character regions is provided, heights of the plurality of character regions are respectively scaled down or up, configured for the plurality of character regions to have the same height. Thus, the precision of calculation is improved.

In an example, the object recognition module may use a neural network model having a time sequence prediction function to recognize the symbol content of each character. Thus, a Long Short-Term Memory (LSTM) or a Temporal Convolutional Network (TCN) can be used to recognize the symbol content of each character, achieving undefined length text recognition and context processing capacities.

In an example, the character recognition method further includes detecting a space character in the at least one character region through a space character detection module to separate the plurality of characters in the at least one character region into a plurality of character strings according to the space character, and selecting each character string to form a character string box; storing a plurality of vocabularies relevant to a content of the input image in a database, with each vocabulary including at least one approximate character string and a correct character string; comparing, after the object recognition module recognizes the symbol content of the character in each character box, the character string in each character string box with the at least one approximate character string and the correct character string of each vocabulary; and outputting, if the character string is the same as the at least one approximate character string or the correct character string of one vocabulary, the character string as the correct character string of the vocabulary. Thus, the plurality of characters may be separated by the space character to form the plurality of character strings; and each character string is compared with the stored relevant vocabularies to determine whether both are approximate or completely match, so as to output the correct character string. The accuracy of the output character string is thereby improved.

In an example, if the character string is not the same as the at least one approximate character string and the correct character string of each vocabulary, a similarity between the character string and the at least one approximate character string of each vocabulary is calculated, and the correct character string of a vocabulary corresponding to an approximate character string having the highest similarity with the character string is taken as an output. Thus, the overall recognition rate is improved by correcting the character.

In an example, if the similarity between the approximate character string and the character string is not more than a similarity threshold, a branch distance that the character string passes through the at least one approximate character string of each vocabulary is calculated through a Burkhard Keller (BK) tree and a Levenshtein distance formula, and the correct character string corresponding to an approximate character string having a minimum distance is taken as the output. Thus, the overall recognition rate is improved by correcting the character.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a flowchart of a character recognition method according to the present invention.

FIG. 2 is a schematic diagram of an operation parameter of a character recognition method for determining a format of a character according to the present invention.

FIG. 3 is a schematic diagram of an input image of a character recognition method according to the present invention.

FIG. 4 is a partial enlarged diagram of FIG. 3.

In the various figures of the drawings, the same numerals designate the same or similar parts. Furthermore, when the terms “front”, “rear”, “left”, “right”, “upper (top)”, “lower (bottom)”, “inner”, “outer” and “side” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

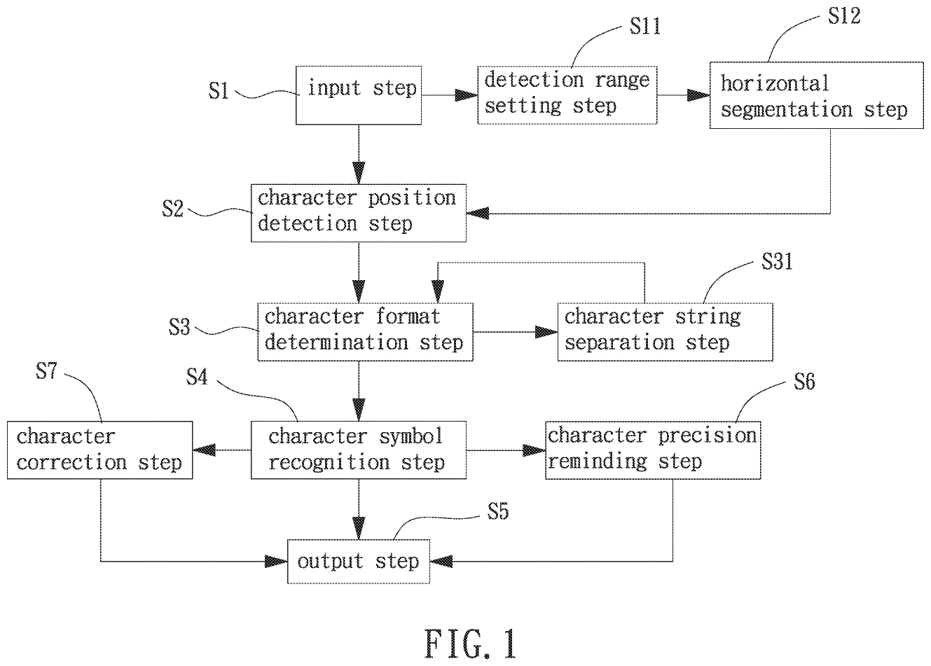

Referring to FIG. 1, a preferred embodiment of the character recognition method according to the present invention includes an input step S1, a character position detection step S2, a character format determination step S3, a character symbol recognition step S4 and an output step S5.

The input step S1 includes inputting an input image of a document, with the input image including a plurality of characters. A character string may be formed by at least one character. Two adjacent character strings can be separated by a space character. In the embodiment, the input image may be a digital image of an engineering drawing specification of an electronic part, and each character may be the USA Standard Code for Information Interchange (US-ASCII) and/or Unicode such as the digit, English symbol, mathematical format symbol and/or special symbol. The input image may be generated in a manner of converting the Portable Document Format (PDF) document content of the engineering drawing specification of the electronic part into the picture format and then performing optical character recognition. The manner of generating the input image is limited in the present invention. Furthermore, it may be understood by one of ordinary skill in the art that each character may also be a letter combined into the word of another language, such as Japanese, French, German or Russian.

The character position detection step S2 may include selecting the plurality of characters in the input image through an object detection module to form at least one character region, and acquiring an image coordinate of the at least one character region in the input image.

Specifically, the object detection module may use an object detection network based on convolutional neural networks such as Efficient and Accurate Scene Text (EAST), Region Based Convolutional Neural Networks (R-CNN), Fast Region Based Convolutional Neural Networks (Fast R-CNN), Faster Region Based Convolutional Neural Network (Faster R-CNN), real-time object detection model (You Only Look Once, YOLO, YOLOv2 and YOLOv3) or Single Shot MultiBox Detector (SSD), so as to select the plurality of characters in the input image to form the at least one character region. In the embodiment, the object detection module may generate the at least one character region in the input image through the EAST object detection network. The object detection network may set a maximum interval between the characters so as to merge the characters on the same line, which is the ordinary skill in the art and is therefore omitted in the present invention.

The character format determination step S3 includes separating the plurality of characters in the character region into independent characters to form a plurality of character boxes, and acquiring data such as a central coordinate, a height value and a width value of each of the plurality of character boxes. In the embodiment, the plurality of characters in the character region may be separated by the EAST object detection network. However, the present invention is not limited in this regard. Preferably, the size of each of the plurality of character boxes may be limited within [−1:1] by regularization, so as to unify the size of the character boxes of the characters of the same format.

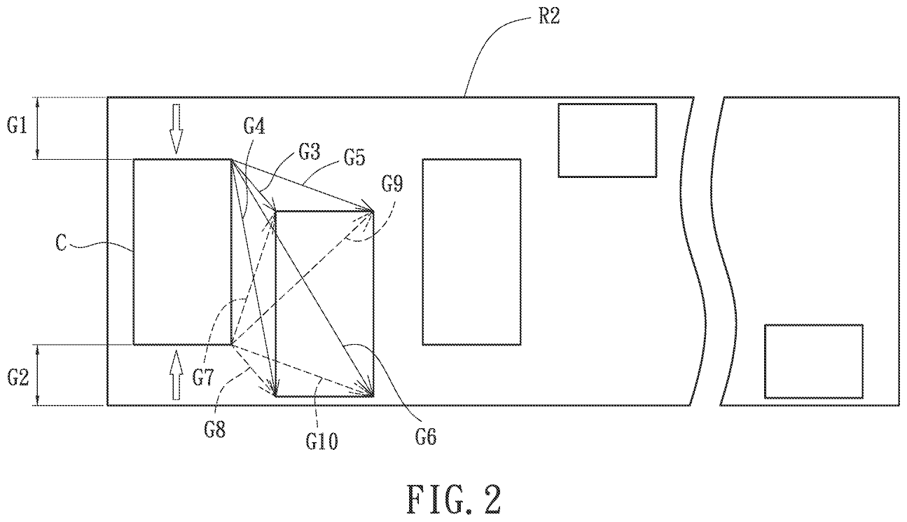

Referring to FIG. 2, after the data of each character box C in the character region R2 are acquired, calculation may be performed according to the central coordinate and the height value of each character box C as well as the image coordinate of the character region R2 to acquire a vector distance between each character box C and an upper boundary and a lower boundary of the character region R2, so as to generate a first distance G1 and a second distance G2. In addition, vectors between right upper and right lower vertex coordinates of each character box C and left upper, left lower, right upper and right lower vertex coordinates of the right character box C thereof are computed to generate a third distance G3 to a tenth distance G10. The character format determination step S3 may include determining whether the character in each character box C is the upper case, the lower case, the superscript or the subscript or another character format according to data of the first distance G1 to the tenth distance G10.

For example, in the first distance G1 to the tenth distance G10, ten vectors within [−1:1] may be acquired in total. The plurality of vectors is serially connected in sequence from the first distance G1 to the tenth distance G10 to form a one-dimensional array, and the one-dimensional array serves as an input data and is input to a classification network for classification, thereby acquiring the format of the character in the character box C. In the embodiment, the classification network may be trained in the supervised learning manner, and may be, for example, a neural network such as the Convolutional Neural Network (CNN), LSTM or Gate Recurrent Unit (GRU). The output format of the classification network may include the character format such as Normal (upper case), Normal (lower case), superscript and subscript.

Preferably, the character format determination step S3 may include performing a character string separation step S31 before the plurality of characters in the character region are separated. The character string separation step S31 may include detecting a space character in the character region through a space character detection module to separate the plurality of characters in the character region into a plurality of character strings according to the space character, and selecting each character string to form a character string box. In the embodiment, the space character detection module may use the EAST object detection network to select the plurality of character boxes in the character region to form the plurality of character string boxes. However, the present invention is not limited in this regard. Hence, the character format determination step S3 may include separating a plurality of characters in each character string box in the character region to form the plurality of character boxes, and acquiring the number of characters in each character string box to generate the first number of characters.

The character symbol recognition step S4 includes recognizing the characters in the character region through an object recognition module to determine a symbol content of the character in each character box. Specifically, the object recognition module may use a neural network model having a time sequence prediction function, such as an LSTM, a TCN and other text recognition models, to recognize the symbol content of the character in each character box through functions of undefined length text recognition and context processing capacities. The number of characters in each character string box for selecting the character box may also be calculated to generate the second number of characters. In the embodiment, the TCN may be used to recognize the symbol content of the characters in each character box. For example, the basic model of the object recognition model is constructed, and the training image may be an image including symbols of the code such as the US-ASCII or/and Unicode.

The output step S5 may converting the plurality of characters in the input image into corresponding editable characters according to the format and symbol content of the character in each character box, and outputting the plurality of editable characters. Preferably, the output step S5 may include comparing whether the first number of characters and the second number of characters of each character string box are the same, and directly outputting the plurality of editable characters if a comparison result is yes; and if the comparison result is no, editable characters converted by characters in character string boxes having the first number of characters and the second number of characters which are not the same are labeled in a manner of highlighting or bottom line and output to remind a user of that a recognition result may be wrong.

Preferably, the character recognition method according to the present invention may further include performing a detection range setting step S11 before the character position detection step S2. The detection range setting step S11 includes setting a Region of Interest (ROI) in the input image in advance, such that the object detection module only performs character position detection on the ROI. That is, the object detection module only selects a plurality of characters in the ROI, thereby reducing the operation processing time of the object detection module.

It should also be noted that, in order to have the object detection module select characters on different lines in the input image to form a plurality of character regions, a horizontal segmentation step S12 may be performed in the embodiment. The horizontal segmentation step S12 may perform horizontal segmentation on the input image with a projection method. Specifically, the projection method may include performing horizontal projection on two upper and lower adjacent lines of characters in the input image, and acquiring a separation point according to a blank region between the two lines of characters. If the input image is black lettering on a white background, the separation point may be acquired by counting the number of pixels having a gray-scale value of 0 on each line between the two lines of characters. When a difference between the numbers of pixels on the two upper and lower lines is more than a threshold value, it may be indicated that the upper line is located in the blank region, and the lower line is located below the blank region. Hence, the coordinate of the upper line can serve as the separation point, such that the object detection module respectively selects the characters on the different lines according to the separation point to form the plurality of character regions.

Preferably, heights of the plurality of character regions may further be respectively scaled down or up, such that the plurality of character regions have the same height. In the embodiment, the height of each character region may be 32-pixel. Further, the plurality of character regions may have the same width, and may also have different widths, which is not limited in the present invention.

Additionally, when the characters in the input image are different in color, gray-level transformation may be performed on the input image in advance, and then the horizontal segmentation step S12 is performed, which may be understood by one of ordinary skill in the art.

The character recognition method according to the present invention may further include a character precision reminding step S6. The character precision reminding step S6 may include evaluating a precision of recognition on each character according to a model evaluation indicator of the object recognition model. Preferably, only characters that are not easily recognized such as “@”, “δ”, “φ”, “θ” and “λ” and characters that are easily recognized to be wrong such as “h”, “n” and “l” are used for evaluation, thereby improving the overall recognition rate and reducing the overall operation processing time.

For example, the model evaluation indicator may be a precision, a recall or an F-score. In the embodiment, whether each character is correct is evaluated based on whether the F-score is not less than a score threshold (such as 0.95). Specifically, when the F-score of one character recognized by the object recognition module is less than the score threshold, the editable character corresponding to the character may be labeled in the manner of highlighting or bottom line through the output step S5 and output, so as to remind the user of that the recognition result may be wrong.

The character recognition method according to the present invention may further include a character correction step S7. The character correction step S7 includes storing a plurality of vocabularies relevant to a content of the input image in a database. Each vocabulary includes at least one approximate character string and a correct character string. After the object recognition module recognizes the symbol content of the character in each character box, the character string in each character string box may be compared with the at least one approximate character string and the correct character string of each vocabulary in the database. The character string is composed of characters in each character string box. If the character string is the same as at least one approximate character string or a correct character string of one vocabulary, the output step S5 may output the character string as the correct character string of the vocabulary; if the character string is not the same as the at least one approximate character string and the correct character string of each vocabulary, a similarity between the character string and the at least one approximate character string of each vocabulary is calculated, and a correct character string of a vocabulary corresponding to an approximate character string having the highest similarity with the character string is taken as output of the output step S5, and whether the similarity between the approximate character string and the character string is more than a similarity threshold is determined. In the embodiment, the similarity threshold may be 1-Word Error Rate (WER), and the WER is 0.1. If the determination result is yes, the character string is output as the correct character string through the output step S5; and if the determination result is no, editable characters corresponding to the character string are output and labeled through the output step S5, so as to remind the user of that the recognition result may be wrong. Specifically, when the similarity is calculated with the WER indicating how many times of substitutions, deletions and insertions must be carried out until the correct vocabulary is obtained. Alternatively, the similarity is calculated with a Hamming Distance. However, the present invention is not limited in this regard.

It should also be noted that if the similarity between the character string and the at least one approximate character string is not more than a similarity threshold, the character correction step S7 may include calculating a branch distance that the character string passes through the at least one approximate character string of each vocabulary through a Burkhard Keller (BK) tree and a Levenshtein distance formula, and a correct character string corresponding to an approximate character string having a minimum distance is taken as the output of the output step S5.

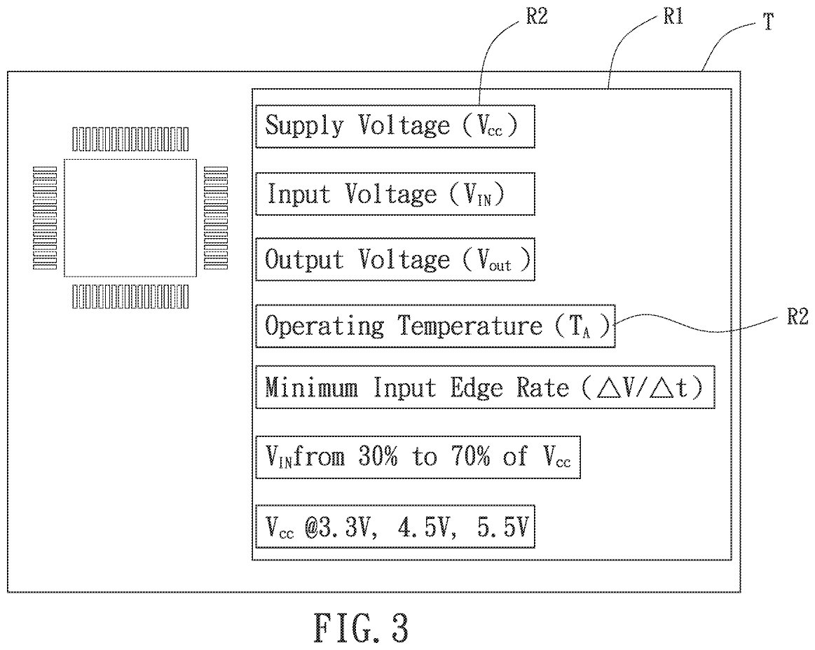

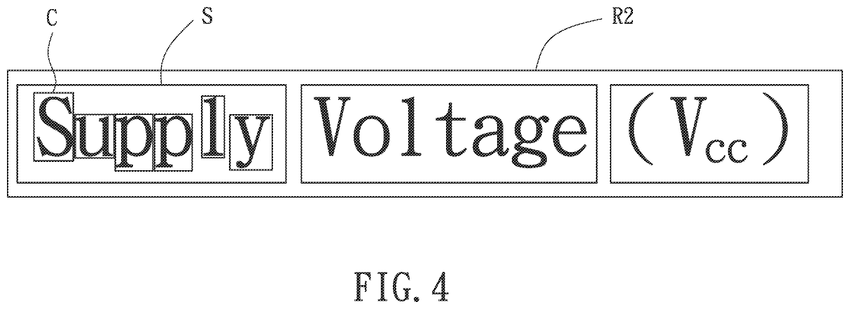

Referring to FIGS. 3 and 4, there is the input image T of the engineering drawing specification of the electronic part. The character recognition method according to the present invention may execute the detection range setting step S11 when performing character recognition on the input image T, so as to set an ROI R1 for the input image T. The horizontal segmentation step S12 is executed, so as to perform horizontal projection on two upper and lower adjacent lines of characters in the ROI R1 of the input image T with a projection method to acquire a separation point between the two lines of characters. The character position detection step S2 is executed, such that the object detection module respectively selects characters on different lines according to the separation point to form a plurality of character regions R2, and acquires an image coordinate of each character region R2 in the input image. The character string separation step S31 is executed, to separate a plurality of characters in each character region R2 into a plurality of character strings according to a space character and select each character string to form a character string box S. The character format determination step S3 is executed, such that a plurality of characters in the character string box S are separated into independent characters to form a plurality of character boxes C, data such as a central coordinate, a height value and a width value of each character box C are acquired. The size of each character box C is limited to [−1:1] by regularization, so as to unify the size of the character box of the character of the same format.

By calculation according to the central coordinate, the height value and the width value of each character box C as well as the image coordinate of the character region R2, a format of the character in each character box C can be determined. The character symbol recognition step S4 is executed, so as to determine a symbol content of the character in each character box C. The plurality of characters in the input image are converted into corresponding editable characters according to the format and symbol content of the character in each character box, and the plurality of editable characters are output.

The above method embodiment of the present invention may further be written into computer programs, such as a character recognition program for recognizing the format and symbol content of the character, with program languages such as C++, Java, Python or Julia. The manner of writing the program code may be understood by one of ordinary skill in the art, and may be used to generate a computer program product with a stored program. The computer program product may perform the above method embodiment of the present invention after a computer system loads and executes the stored program.

The computer program product may further be stored on a computer readable medium with the stored program, such as an optical disc, a hard disk, a Universal Serial Bus (USB) flash drive, and various memory cards, and cloud or virtual storage spaces. The computer readable medium may perform the above method embodiment of the present invention after a computer system loads and execute the stored program, to serve as a basis that software and hardware of the computer system of the present invention operate collaboratively.

In summary, the character recognition method, the computer program product with the stored program and the computer readable medium with the stored program according to the present invention can select a plurality of characters in an input image of a document to form at least one character region; separate the plurality of characters in the character region to form a plurality of character boxes and acquire data such as a central coordinate, a height value and a width value of each character box; then perform calculation according to the data of each character box and an image coordinate of the character region to determine a format of a character in each character box; additionally recognize the characters in the character region through an object recognition module to determine a symbol content of the character in each character box; and then convert the plurality of characters in the input image into corresponding editable characters according to the format and symbol content of the character in each character box, and output the plurality of editable characters. Therefore, the character recognition method, the computer program product with the stored program and the computer readable medium with the stored program according to the present invention can achieve the effect of recognizing formats such as upper cases, lower cases, superscripts and subscripts of the characters.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A character recognition method, comprising:
inputting an input image of a document, with the input image including a plurality of characters;
selecting the plurality of characters through an object detection module to form at least one character region, and acquiring an image coordinate of the at least one character region in the input image;
separating the plurality of characters in the at least one character region into independent characters to form a plurality of character boxes, and acquiring a central coordinate, a height value and a width value of each of the plurality of character boxes;
performing calculation according to the central coordinate, the height value and the width value of each of the plurality of character boxes as well as the image coordinate of the at least one character region to determine a format of a character in each of the plurality of character boxes;
recognizing the characters in the at least one character region through an object recognition module to determine a symbol content of the character in each of the plurality of character boxes; and
converting the plurality of characters in the input image into corresponding editable characters according to the format and the symbol content of the character in each of the plurality of character boxes, and outputting the plurality of editable characters.

2. The character recognition method as claimed in claim 1, wherein the object detection module generates the at least one character region in the input image through an object detection network.

3. The character recognition method as claimed in claim 1, further comprising performing a projection method on the input image to acquire a separation point between two upper and lower adjacent lines of characters in the input image, configured for the object detection module to respectively select characters on different lines according to the separation point to form a plurality of character regions.

4. The character recognition method as claimed in claim 1, wherein when a plurality of character regions is provided, heights of the plurality of character regions are respectively scaled down or up, configured for the plurality of character regions to have a same height.

5. The character recognition method as claimed in claim 1, wherein the object recognition module uses a neural network model having a time sequence prediction function to recognize the symbol content of each character.

6. The character recognition method as claimed in claim 1, further comprising detecting a space character in the at least one character region through a space character detection module to separate the plurality of characters in the at least one character region into a plurality of character strings according to the space character, and selecting each character string to form a character string box; storing a plurality of vocabularies relevant to a content of the input image in a database, with each vocabulary comprising at least one approximate character string and a correct character string; comparing, after the object recognition module recognizes the symbol content of the character in each character box, the character string in each character string box with the at least one approximate character string and the correct character string of each vocabulary; and outputting, if the character string is the same as the at least one approximate character string or the correct character string of one vocabulary, the character string as the correct character string of the vocabulary.

7. The character recognition method as claimed in claim 6, wherein if the character string is not the same as the at least one approximate character string and the correct character string of each vocabulary, a similarity between the character string and the at least one approximate character string of each vocabulary is calculated, and the correct character string of a vocabulary corresponding to an approximate character string having the highest similarity with the character string is taken as an output.

8. The character recognition method as claimed in claim 7, wherein if the similarity between the approximate character string and the character string is not more than a similarity threshold, a branch distance that the character string passes through the at least one approximate character string of each vocabulary is calculated through a Burkhard Keller (BK) tree and a Levenshtein distance formula, and the correct character string corresponding to the approximate character string having a minimum distance is taken as the output.

9. A computer program product with a stored program, which is capable of performing the character recognition method as claimed in claim 1 after a computer system loads and executes the stored program.

10. A computer readable medium with a stored program, which is capable of performing the character recognition method as claimed in claim 1 after a computer system loads and executes the stored program.
